(19) United States
(12) Patent Application Publication
(10) Pub. No.: US 2012/0149551 A1
(43) Pub. Date: Jun. 14, 2012

(54) TWO-LAYER CATALYST, PROCESS FOR PREPARING SAME AND USE FOR THE MANUFACTURE OF NANOTUBES

(75) Inventors: Patrice Gaillard, Hagetaubin (FR); Serge Bordere, Jurancon (FR); Philippe Serp, Clermont-le-Fort (FR); Brigitte Caussat, Ramonville-Saint-Agne (FR); Julien Beausoleil, Toulouse (FR)

(73) Assignees: INSTITUT NATIONAL POLYTECHNIQUE DE TOULOUSE (INPT), Toulouse (FR); ARKEMA FRANCE, Colombes (FR)

(21) Appl. No.: 13/391,100

(22) PCT Filed: Aug. 16, 2010
(86) PCT No.: PCT/FR2010/051717

§ 371 Date: Feb. 17, 2012

(30) Foreign Application Priority Data
Aug. 17, 2009 (FR) 09 55692

(51) Int. Cl. D01F 9/127; B01J 23/881; B01J 21/04; B01J 21/18; B01J 21/08; B01J 21/06; B01J 29/04; D01F 9/12; H01B 1/24; B01J 23/85; B01J 21/10; B82Y 30/00; B82B 1/00; B82B 3/00

(52) U.S. Cl. 502/74; 502/316; 502/314; 502/185; 502/254; 502/306; 502/309; 502/308; 423/447.3; 423/447.2; 252/511; 977/742; 977/843; 977/932

(57) ABSTRACT

A catalyst material for preparing nanotubes, especially carbon nanotubes, said material being in the form of solid particles, said particles including a porous substrate supporting two superposed catalytic layers, a first layer, directly positioned on the substrate, including at least one transition metal from column VIB of the Periodic Table, preferably molybdenum, and a second catalytic layer, positioned on the first layer, comprising iron. Also, a process for preparing same and to a process for the synthesis of nanotubes using this catalyst material.

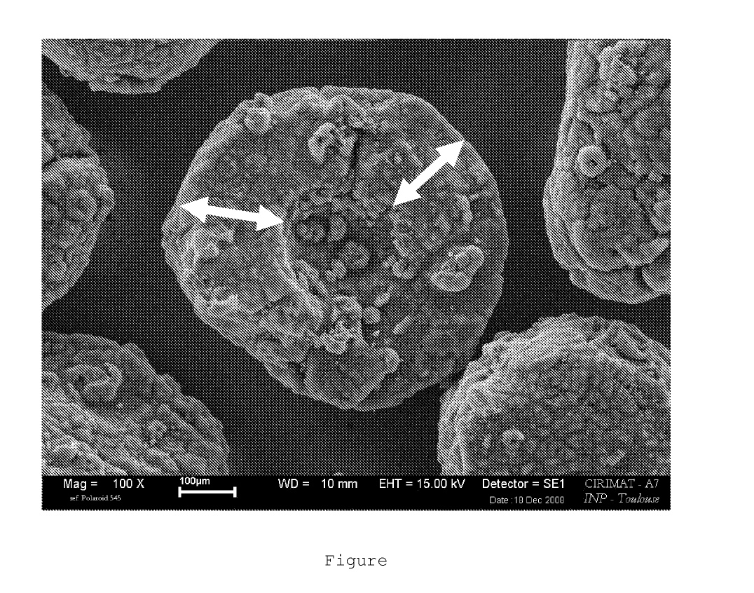

### CROSS-REFERENCE TO RELATED APPLICATIONS

The present application is a national stage application of international application no. PCT/FR2010/051717, filed on Aug. 16, 2010, which claims priority of French application no. 0955692, filed on Aug. 17, 2009. Each of international application no. PCT/FR2010/051717, French application no. 0955692, and U.S. provisional application No. 61/228,740 are hereby incorporated by reference in entirety.

### TECHNICAL FIELD

The present invention relates to novel two-layer catalysts. It also relates to the process for preparing these catalysts and their use for the manufacture of nanotubes, especially carbon nanotubes.

### BACKGROUND

Many studies have focused on catalysts of the supported transition metal type, in particular for the manufacture of carbon nanotube (CNT) powder.

CNTs have in recent years been the subject of intensive research, with a view to replacing the volatile and difficult to handle carbon black powder in all its applications. CNTs also have the advantage of imparting improved mechanical properties and electric and/or heat conduction properties to any composite material containing them, which are at least equal to those of pulverulent carbon black, at lower contents. Their good mechanical properties and especially the property of resistance to elongation are partly linked to their very high (length/diameter) aspect ratios.

They are composed of one or more graphite sheets arranged concentrically about a longitudinal axis. For nanotubes composed of a single sheet, reference is made to SWNTs (single-walled nanotubes) and for nanotubes composed of several concentric sheets, reference is then made to MWNTs (multiwalled nanotubes). SWNTs are in general more difficult to manufacture than MWNTs.

Carbon nanotubes may be manufactured according to various processes such as electrical discharge, laser ablation, chemical vapor deposition (CVD) or physical vapor deposition (PVD).

According to the applicant, the process for manufacturing CNTs that is the most promising in terms of the quality of the CNTs, the reproducibility of the characteristics of the CNTs and productivity is the CVD process. This process consists in injecting a source of carbon-rich gas into a reactor containing a metallic catalyst brought to high temperature. In contact with the metal, the gas source decomposes to graphite-plane CNTs and hydrogen. In general, the catalyst consists of a catalytic metal such as iron, cobalt or nickel, supported by a solid substrate, in the form of grains, and that is chemically inert, such as alumina, silica, magnesia or else carbon.

The gaseous sources of carbon generally used are methane, ethane, ethylene, acetylene or benzene.

By way of example of documents that describe this CVD process, mention may be made of document WO 86/03455 by Hyperion Catalysis International Inc. that can be considered to be one of the base patents on the synthesis of CNTs. This document describes carbon fibrils (former name of CNTs) that are quasi-cylindrical, the diameter of which is between 3.5 and 70 nm and the aspect ratio of which is greater than or equal to 100, and also their preparation method.

The CNTs are synthesized by bringing a catalyst containing iron (for example Fe₃O₄, Fe on a charcoal support, Fe on an alumina support or Fe on a carbon-containing fibril support) into contact with a carbon-rich gaseous compound, such as a hydrocarbon, in the presence of another gas capable of reacting with the carbon-rich gaseous compound. The synthesis is carried out at a temperature chosen from the range extending from 850° C. to 1200° C. The catalyst is prepared by dry impregnation, by precipitation or by wet impregnation.

Other documents describe improvements to this process, such as the use of a continuous fluidized bed of catalyst, which makes it possible to control the degree of agglomeration of the catalyst and of the carbon-based materials formed (see, for example WO 02/94713A1 in the name of the University of Tsinghua and FR 2 826 646 INPT).

Many studies have also focused on improvement of the catalyst, especially by combination of various catalytic metals. Thus, US 2001/00036549 by Hyperion Catalysis International Inc. described supported bimetallic catalysts of Fe/Mo and Fe/Cr type and demonstrated that molybdenum doping of the order of 1 to 2% by mass made it possible to double the productivity relative to an iron monometallic catalyst, in a temperature range from 500° C. to 1500° C., but that doping beyond 2.5% made the productivity drop. Mention may also be made of patent application US 2008/0003169 which describes catalysts of Fe/Mo/alumina type enabling good productivity. However, in this case, the catalyst has a structure different from that of a supported catalyst since it is obtained by coprecipitation, on the one hand, of a solution of iron salts and of molybdenum salts and, on the other hand, of a solution of aluminum salts.

The applicant has proposed in its patent application WO 2006/082325 a novel type of supported catalyst which may combine several types of metals. However, this document concentrates solely on examples of an Fe/alumina catalyst.

Finally, document EP 2 077 251 discloses a supported catalyst for the production of single-walled carbon nanotubes. This supported catalyst consists of a flat substrate, made of quartz glass or of cordierite, covered with a support based on non-porous alumina, deposited on which are, according to a given process, catalytic metals (molybdenum and iron). The latter form a thin layer, which results in a low catalytic activity of the catalysts from EP 2 077 251, which leads to the formation of a film of carbon nanotubes, the thickness of which does not exceed 10 μm.

Despite these various developments, there is still a need for new catalysts, which make it possible to further improve the productivity of the CNT synthesis reactions in which they are used.

### BRIEF SUMMARY OF THE DISCLOSURE

The present inventors have found that a supported catalyst having a structure of “core-shell” type enabled this improvement.

The invention thus aims to propose a catalyst material for the preparation of nanotubes, especially carbon nanotubes, said material being in the form of solid particles, said particles comprising (and preferably consisting of) a porous substrate supporting two superposed catalytic layers, a first layer (referred to as the “core”), positioned directly on the substrate, comprising at least one transition metal, especially in the reduced or metal state, from column VIB of the Periodic Table, preferably molybdenum, and a second layer (referred to as the “shell”) positioned on the first and comprising iron.

It is clearly understood that, in the present description, the expression “at least one metal” means one or more metals. Moreover, it is specified that “iron” and “transition metal” refers to these metals in the elemental state, that is to say in the 0 oxidation state, or in the oxidized state. It is preferred however that these metals are mainly in the elemental state.

Such a catalyst material thus has a core-shell structure positioned on a porous substrate.

### DETAILED DESCRIPTION OF THE DISCLOSURE

The transition metal present in the first layer or core is preferably chromium, molybdenum, tungsten or mixtures thereof. Advantageously, molybdenum is used. In the synthesis of carbon nanotubes, these catalytic metals are known as having a reaction-initiating role, and their presence is therefore useful at the start of the carbon nanotube synthesis reaction. Iron, present in the second layer or shell, is itself known as playing a role during the elongation of the chain of carbon nanotubes. The present inventors have observed that the synthesis of CNTs takes place from the inside of the catalyst to the outside and, without wishing to be tied to any one theory, they are of the opinion that by placing the initiating catalytic metal closer to the part of the catalyst material where the initiation takes place, that is to say toward the inside of the catalyst material, and the chain-elongating catalytic metal more toward the outside, the synthesis of CNTs is favored.

The core may comprise, in addition to the transition metal from column VIB of the Periodic Table, iron. In this case, in the core, the amount, by mass, of iron may be less than the amount, by mass, of transition metal from column VIB of the Periodic Table. Likewise, the shell may also comprise a transition metal from column VIB of the Periodic Table, preferably molybdenum, in addition to iron. In this case, in the shell, the amount, by mass, of transition metal from column VIB of the Periodic Table is generally less than the amount, by mass, of iron.

According to one advantageous embodiment, the catalyst according to the invention comprises (or even consists of) a first catalytic layer comprising, as sole catalytic metal, molybdenum, deposited on which is a second catalytic layer comprising, as sole catalytic metal, iron.

The iron content of the catalyst material according to the invention is at least 25%, preferably from 30% to 40% by mass of the total mass of the catalyst material.

The content of transition metal from column VIB of the Periodic Table, preferably molybdenum, is from 0.5% to 10%, in particular from 1.5% to 8%, preferably from 2% to 4% by mass of the total mass of the catalyst material.

The porous substrate advantageously has a BET specific surface area of greater than 50 m²/g, preferably of between 70 and 400 m²/g. The BET specific surface area may be measured by the amount of nitrogen adsorbed by the substrate, which method is well known to those skilled in the art.

The substrate is preferably inert, namely chemically inert with respect to the transition metal and iron and the gaseous source of carbon, under the operating conditions of the CVD synthesis process. Advantageously, this substrate is made from an inorganic material. It represents, in particular, from 50% to 85%, for example from 52% to 83.5%, by mass of the catalyst material.

The substrate may be chosen from alumina, activated charcoal, silica, a silicate, magnesia, titanium oxide, zirconia, a zeolite or else carbon fibers. According to one advantageous embodiment, the substrate is alumina, for example of gamma or theta type.

The macroscopic form of the substrate particles, and of the catalyst material particles, may be overall substantially spherical or not. The invention also applies to grains having a macroscopic shape that is more or less flattened (flakes, discs, etc.) and/or elongated (cylinders, rods, ribbons, etc.). In any case, the substrate is in pulverulent form and not in an agglomerated, especially planar form.

According to the invention, the shape and the dimension of the particles are suitable for allowing the formation of a fluidized bed of the catalyst material. In practice, in order to ensure a reasonable productivity, it is preferred that the substrate particles have a larger dimension between 20 and 500 microns, preferably between 75 and 150 microns. This particle size may be measured by dry or wet laser particle size analysis.

Furthermore, according to one embodiment of the invention, the catalyst material is in the form of spherical particles having a unimodal particle size distribution, the equivalent diameter of the particles being between 80% and 120% of the average diameter of the particles of the catalyst material. As a variant, the particles may have a bimodal particle size distribution with an equivalent diameter ranging from 30% to 350%.

Advantageously, the catalyst material according to the invention comprises alumina particles supporting a molybdenum core on which an iron shell is positioned, the mass percentages of the various constituents being 32 for iron, 2 for molybdenum and 66 for alumina, relative to the total mass of the catalyst material.

The invention extends to a process for preparing the catalyst material described previously, which comprises a first step of impregnation of the substrate with an impregnation solution comprising a salt of a transition metal from column VIB of the Periodic Table, preferably molybdenum, and a second step of impregnation with an impregnation solution comprising an iron salt. Each of the impregnation solutions may be an alcoholic or aqueous solution. The iron salt may be an iron nitrate, and in particular iron nitrate nonahydrate. The molybdenum salt may be ammonium molybdate, and especially ammonium molybdate tetrahydrate. Advantageously, the first impregnation solution is an aqueous solution of ammonium molybdate and the second solution is an aqueous solution of iron nitrate nonahydrate.

Each impregnation step is preferably carried out under a stream of dry gas, preferably under a stream of air. It is carried out at a temperature measured in situ ranging from 100 to 150° C., preferably of around 120° C. The amount of impregnation solution, at any moment, in contact with the substrate or the subjacent layer is generally just sufficient to ensure the formation of a film at the surface of the particles of substrate or of the subjacent layer.

The process for preparing the catalytic material according to the invention also comprises, after the impregnation steps, a step of drying at a temperature ranging for example from 150 to 250° C., measured in situ, advantageously followed by a step of denitrification, preferably under an inert atmosphere at a temperature ranging from 350 to 450° C., measured in situ.

The invention also extends to a catalyst material obtained by a process according to the invention as defined above.

The invention also extends to a process for manufacturing nanoparticles of a material chosen from silicon, carbon or boron and a mixture of these elements, optionally combined with nitrogen or doped with nitrogen, characterized in that at least one catalyst material according to the invention is used.

Advantageously and according to the invention, it is a reaction for the selective manufacture of carbon nanotubes by thermal decomposition of a gaseous source of carbon. Thus, the invention relates more particularly to a process for manufacturing carbon nanotubes by decomposition of a source of carbon in the gas state, comprising the following steps:

a) the introduction, especially the placement in a fluidized bed, in a reactor, of a catalyst material as defined previously;
b) the heating of said catalyst material at a temperature ranging from 620 to 680° C., preferably of around 650° C.;
c) the bringing into contact of a source of carbon (alkane or alkene), preferably of ethylene, with the catalyst material from step b), in order to form, at the surface of said catalyst material, carbon nanotubes and hydrogen by catalytic decomposition of said carbon source;
d) the recovery of the carbon nanotubes produced in c).

The source of carbon may be an alkane such as methane or ethane or preferably an alkene which may be chosen from the group comprising ethylene, isopropylene, propylene, butene, butadiene, and mixtures thereof. This source of carbon may be of renewable origin as described in patent application EP 1 980 530. The alkene preferably used is ethylene.

Advantageously and according to the invention, the source of carbon, and preferably ethylene, is mixed in step c) with a stream of hydrogen.

The source of carbon/hydrogen ratio may in this case be between 90/10 and 60/40, preferably between 70/30 and 80/20. Advantageously, step c) is carried out with an ethylene/hydrogen mixture in a ratio of 75/25.

The various steps are preferably carried out simultaneously or continuously in one and the same reactor.

Moreover, this process may comprise other (preliminary, intermediary or subsequent) steps, as long as they do not adversely affect the production of carbon nanotubes.

Thus, advantageously, the catalyst material is reduced in situ in the CNT synthesis reactor. Thus, the catalytic layers are in the reduced state at the moment when the catalyst is used.

If necessary, a step of milling the nanotubes in situ or ex situ relative to the reactor may be envisaged, before or after step d). It is also possible to provide a step of chemical and/or thermal purification of the nanotubes before or after step d).

The productivity obtained with the process of the invention is particularly high, since it is always greater than 20, even greater than 25, said productivity being calculated as the ratio of the mass of carbon formed to the mass of catalyst used. Furthermore, the carbon nanotubes formed have less tendency to agglomerate than in the prior art processes.

The invention also extends to the carbon nanotubes capable of being obtained according to the process described previously. These are advantageously multi-walled nanotubes, comprising for example from 5 to 15, and preferably from 7 to 10, concentrically rolled graphene sheets. The nanotubes obtained according to the invention customarily have an average diameter ranging from 0.1 to 200 nm, preferably from 0.4 to 100 nm, more preferably from 0.4 to 50 nm and better still from 1 to 30 nm and advantageously a length of more than 0.1 μm and advantageously from 0.1 to 20 μm, for example around 6 μm. Their length/diameter ratio is advantageously greater than and usually greater than 100. Their specific surface area is for example between 100 and 600 m²/g and their bulk density may especially be between 0.01 and 0.5 g/cm³ and more preferably between 0.07 and 0.2 g/cm³.

The invention also relates to the use of nanotubes, capable of being obtained as described previously, in composite materials, in order to impart thereto improved electric and/or heat conduction properties and/or improved mechanical properties, especially resistance to elongation. In particular, the CNTs may be used in macromolecular compositions intended for wrapping electronic components or for the manufacture of fuel lines or antistatic coatings or paints, or in thermistors or electrodes for supercapacitors or else for the manufacture of structural parts in the aeronautic, nautical or automotive fields.

The invention will be described in greater detail with reference to the following examples which are given for purely illustrative purposes and are in no way limiting, taken in combination with the appended FIGURE which illustrates a catalyst grain according to the invention covered with a film of carbon nanotubes.

### EXAMPLES

### Example 1

A 25Fe3Mo7Fe/Al₂O₃ catalyst is prepared from Puralox® SCCa-5/150 alumina having a median diameter equal to around 85 μm and a specific surface area of 160 m²/g. In a 1 L reactor equipped with a jacket and heated at 120° C., 100 g of alumina are introduced and the reactor is purged with air. Using a pump, 150 ml of a solution of iron nitrate and ammonium molybdate containing 535 g/l of iron nitrate nonahydrate and 60 g/l of ammonium molybdate tetrahydrate then 520 ml of a solution of iron nitrate containing 535 g/l of iron nitrate nonahydrate are then continuously injected. Since the targeted ratio (mass of metal/mass of catalyst) is 32% for the iron and 3% for the molybdenum, the addition duration is set at 25 h. The catalyst is then heated in situ at 220° C. under a purge of dry air for 8 hours than placed in a muffle furnace at 400° C. for 8 hours.

### Example 2

### Comparative

A 3Mo7Fe25Fe/Al₂O₃ catalyst containing 32% of iron and 3% of molybdenum is prepared under the conditions of example 1 by firstly injecting 520 ml of the iron nitrate solution then 150 ml of the solution of iron nitrate and ammonium molybdate.

### Example 3

A 32Fe2Mo/Al₂O₃ catalyst containing 32% of iron and 2% of molybdenum is prepared under the conditions of example 1, by injecting firstly 90 ml of a solution of ammonium molybdate containing 60 g/l of Mo then 650 ml of a 535 g/l iron nitrate solution.

### Example 4

### Comparative

A 32Fe/Al₂O₃ catalyst is prepared from Puralox® SCCa-5/150 alumina having a median diameter equal to around 85 μm and a specific surface area of 160 m²/g. In a 1 L reactor equipped with a jacket and heated at 120° C., 100 g of alumina are introduced and the reactor is purged with air. Using a pump, 630 ml of an iron nitrate solution containing 535 g/l of iron nitrate nonahydrate are then continuously injected. Since the targeted ratio (mass of iron/mass of catalyst) is 32%, the addition duration is set at 25 h. The catalyst is then heated in situ at 220° C. under a purge of dry air for 8 hours then placed in a muffle furnace at 400° C. for 8 hours.

### Example 5

A catalytic test is carried out by placing a mass of around 2.3 g of catalyst as a layer in a reactor having a diameter of 5 cm and an effective height of 1 meter. It is heated at 650° C. under 2.66 l/min of nitrogen for 30 minutes then a reduction hold is maintained for 30 minutes under 2 l/min of nitrogen and 0.66 l/min of hydrogen. Once this hold has ended, a flow rate of 2 l/min of ethylene and of 0.66 l/min of hydrogen is introduced. After 60 minutes, the heating is stopped and the reactor is cooled under a 2.66 l/min stream of nitrogen. The amount of product formed is evaluated by calculating the mass remaining after a calcination of around 2 g of composite at 800° C. for 6 hours.

| Catalyst of | | Productivity | Activity |
|---|---|---|---|
| example | Reference | (g_{c}/g_{catalyst}) | (g_{c}/gₘₑₜₐₗ/h) |
| 1 | 25Fe3Mo7Fe/Al₂O₃ | 29 | 82.9 |
| 2 | 3Mo7Fe25Fe/Al₂O₃ | 17 | 48.6 |
| 3 | 32Fe2Mo/Al₂O₃ | 26 | 76.5 |
| 4 | 32Fe/Al₂O₃ | 15 | 46.9 |

The catalysts in accordance with the invention make it possible to obtain a carbon nanotube productivity and an activity that are greater than those obtained with the catalysts from the comparative examples.

The appended FIGURE furthermore illustrates a catalyst grain according to the invention, covered with a film of carbon nanotubes which is formed according to a process similar to that described above. As shown in this FIGURE, the film of nanotubes has a thickness of greater than 100 μm. In order to obtain a film thickness value more representative of the whole of the sample tested, a particle size analysis of the catalyst grains was carried out at the end of the reaction. After subtracting the average diameter (D50) of the catalyst grains before reaction, it was deduced therefrom that the average thickness of the film of nanotubes was, for this sample, approximately 200 μm.

The nanotubes obtained according to the invention may be introduced into a polymer matrix in order to produce composite materials having improved mechanical and/or thermal and/or conductive properties.

1. A catalyst material for the preparation of nanotubes, said material being in the form of solid particles, said particles comprising a porous substrate supporting two superposed catalytic layers, a first catalytic layer, positioned directly on the substrate, comprising at least one transition metal from column VIB of the Periodic Table, and a second catalytic layer positioned on the first and comprising iron,
wherein the porous substrate has a BET specific surface area of greater than 50 m²/g.

2. The catalyst material as claimed in claim 1, wherein the first catalytic layer also comprises iron, and/or the second catalytic layer also comprises a transition metal from column VIB of the Periodic Table.

3. The catalyst material as claimed in claim 1, wherein the first catalytic layer comprising, as sole catalytic metal, molybdenum, deposited on which is the second catalytic layer comprising, as sole catalytic metal, iron.

4. The catalyst material as claimed in claim 1, wherein the iron content is at least 25% by mass of the total mass of the catalyst material.

5. The catalyst material as claimed in claim 1, wherein the content of transition metal from column VIB of the Periodic Table is from 0.5% to 10% by mass of the total mass of the catalyst material.

6. The catalyst material as claimed in claim 1, wherein the porous substrate has a BET specific surface area of between 70 and 400 m²/g.

7. The catalyst material as claimed in claim 1, wherein the substrate is chosen from alumina, activated charcoal, silica, a silicate, magnesia, titanium oxide, zirconia, a zeolite and carbon fibers.

8. The catalyst material as claimed in claim 1, wherein the substrate particles have one larger dimension between 20 and 500 microns.

9. The catalyst material as claimed in claim 3, wherein the substrate is made of alumina and supports a first layer of molybdenum on which a second layer of iron is placed, and the mass percentages of the various constituents are 32 for iron, 2 for molybdenum and 66 for alumina, relative to the total mass of catalyst material.

10. A process for preparing the catalyst material as claimed in claim 1, the process comprising impregnation of the substrate with a first impregnation solution comprising a salt of a transition metal from column VIB of the Periodic Table, then impregnation with a second impregnation solution of iron salt.

11. The process as claimed in claim 10, in which each impregnation is carried out at a temperature ranging from 100 to 150° C., measured in situ.

12. The process as claimed in claim 10, wherein the amount of impregnation solution, at any moment, in contact with the substrate or the subjacent layer is just sufficient to ensure the formation of a film at the surface of the particles of substrate or of subjacent layer.

13. The process as claimed in claim 10, which comprises, after the impregnation steps, a step of drying at a temperature ranging from 150 to 250° C., measured in situ.

14. A process for manufacturing nanotubes comprising the following steps:
a) the introduction, in a reactor, of a catalyst material as defined in claim 1;
b) the heating of said catalyst material at a temperature ranging from 620 to 680° C.;
c) the bringing into contact of a source of carbon with the catalyst material from step b), in order to form, at the surface of said catalyst, carbon nanotubes and hydrogen by catalytic decomposition of said carbon source;
d) the recovery of the carbon nanotubes produced in c).

15. The process as claimed in claim 14, wherein the source of carbon is mixed in step c) with a stream of hydrogen.

16. The process as claimed in claim 15, wherein the source of carbon/hydrogen ratio is between 90/10 and 60/40.

17. The process as claimed in claim 16, wherein ethylene is used as the source of carbon and the ethylene/hydrogen ratio is 75/25.

18. The carbon nanotubes capable of being obtained according to the process as claimed in claim 14.

19. The use of the carbon nanotubes as claimed in claim 18, in composite materials in order to impart thereto improved electric and/or heat conduction properties and/or improved mechanical properties.

20. The use of the carbon nanotubes as claimed in claim 19, in macromolecular compositions intended for wrapping electronic components or for the manufacture of fuel lines or antistatic coatings or paints, or in thermistors or electrodes for supercapacitors or else for the manufacture of structural parts in the aeronautic, nautical or automotive fields.
